(19) United States
(12) Patent Application Publication
(10) Pub. No.: US 2013/0111577 A1
(43) Pub. Date: May 2, 2013

(54) CONNECTION SERVER, COMMUNICATION SYSTEM, AND COMMUNICATION METHOD

(71) Applicant: BUFFALO INC., Nagoya-shi (JP)

(72) Inventor: Takashi ISHIDOSHIRO, Nagoya-shi (JP)

(73) Assignee: BUFFALO INC., Nagoya-shi (JP)

(21) Appl. No.: 13/657,989

(22) Filed: Oct. 23, 2012

(30) Foreign Application Priority Data
Oct. 31, 2011 (JP) 2011-238318

(51) Int. Cl. G06F 15/173; G06F 21/00

(52) U.S. Cl. 726/11; 709/242; 726/3

(57) ABSTRACT

A connection server connected to a plurality of relay nodes including a first and a second relay nodes. The connection server includes a management part that manages connection information for a first terminal at service of the first relay node to access a second terminal at service of the second relay node, and logical distance information indicative of logical distances between the plurality of relay nodes; a selection part that selects, based on the logical distance information, a plurality of relay paths over which data held by the second terminal is relayed to the first terminal; and a notification section that notifies the connection information to the relay nodes located on the plurality of relay paths.

### CROSS REFERENCE TO RELATED APPLICATION

The present application claims priority to Japanese Patent Application No. 2011-238318 filed on Oct. 31, 2011, the disclosure of which is hereby incorporated by reference in its entirety.

### BACKGROUND OF THE INVENTION

1. Field of the Invention

The present disclosure relates to a connection server, a communication system, and a communication method for relaying data between terminals.

2. Description of Related Art

In the recent years, various techniques have been used to resolve diverse problems stemming from the growing number of communication network users such as those of the Internet. Under such conditions, there have been various technical problems involved where one terminal (called a first terminal) acquires data from another terminal (called a second terminal). In the past, these technical problems have been addressed by known communication systems, some of which are outlined below.

(1) NAT

A technique called NAT (Network Address Translation) is known that translates IP (Internet Protocol) addresses in order to resolve the problem of the depletion of global IP addresses (e.g., IPv4).

Where a local network to which the second terminal is connected is in turn connected to a global network via a NAT-equipped device (router, gateway, etc.), the NAT-equipped device assigns an IP address to the second terminal only if the second terminal needs to conduct communications over the global network. That is, where the NAT is utilized, the IP address of the second terminal is changed. This prevents the first terminal from obtaining the IP address of the second terminal, making it impossible for the first terminal to access the second terminal.

In order to solve the above problem, there are DDNS (Dynamic Domain Name System) and other techniques. Under the DDNS, the IP address assigned to the second terminal is transmitted to a device that manages the IP address of the second terminal. The IP address management device holds IP address information about the second terminal and provides the information in question to the first terminal. This allows the first terminal to acquire the IP address of the second terminal and thereby to access the second terminal.

(2) Firewall

Where the second terminal is connected to an external network via a firewall-equipped device (router, gateway, etc.) for preventing unauthorized access, the first terminal connected to a network outside the firewall cannot access the second terminal freely.

To solve the problem above, PP (Port Punching) and other techniques have been proposed. Under the PP scheme, if the first terminal is successfully authenticated, the first terminal is offered connection information (port number) for gaining access to the second terminal. On acquiring the connection information, the first terminal can access the second terminal.

(3) Relay Nodes

In connection with the systems outlined above, relay nodes for relaying data between the first and the second terminals have also been proposed (e.g., see Japanese Patent Laid-open No. 2006-135591). Specifically, the information identifying the relay node selected by the first terminal is transmitted to the second terminal via a mediation server. Using the relay node thus identified, the first and the second terminals transmit and receive data therebetween.

In cases where the amount of data sent from the second terminal to the first terminal in one session is considerable (e.g., of one file), the single relay node relaying the data comes under a heavy load. For example, if the data transmitted from the second terminal to the first terminal is video or audio data, the load on the single relay node becomes extremely heavy.

### SUMMARY OF THE DISCLOSURE

It is thus an object of the present disclosure to provide a communication system, a communication method, and a connection server which, if the second terminal is at service of a device equipped with the NAT function or the firewall function, allow data to be relayed from the second terminal to the first terminal while alleviating the burden involved with the relaying.

According to one embodiment of the present disclosure, there is provided a connection server connected to a plurality of relay nodes including a first and a second relay nodes, the connection server comprising: a management part that manages connection information for a first terminal at service of the first relay node to access a second terminal at service of the second relay node, and logical distance information indicative of logical distances between the plurality of relay nodes; a selection part that selects, based on the logical distance information, a plurality of relay paths over which data held by the second terminal is relayed to the first terminal; and a notification section that notifies the connection information to the relay nodes located on the plurality of relay paths.

According to another exemplary embodiment of the present disclosure, there is provided a method performed by a connection server connected to a plurality of relay nodes including a first and a second relay nodes, the method comprising: managing, by a processor of the connection server, connection information for a first terminal at service of the first relay node to access a second terminal at service of the second relay node, and logical distance information indicative of logical distances between the plurality of relay nodes; selecting, by the processor based on the logical distance information, a plurality of relay paths over which data held by the second terminal is relayed to the first terminal; and notifying, by a communication interface of the connection server, the connection information to the relay nodes located on the plurality of relay paths.
According to another exemplary embodiment of the present disclosure, there is provided a communication system, comprising: a plurality of relay nodes; and a connection server configured to manage said plurality of relay nodes, the connection server including a management part that manages connection information for a first terminal at service of a first of the plurality of relay nodes to access a second terminal at service of a second of the plurality of relay nodes, and logical distance information indicative of logical distances between the plurality of relay nodes; a selection part that selects, based on the logical distance information, a plurality of relay paths over which the data held by the second terminal is relayed to the first terminal; and a notification section that notifies the connection information to the relay nodes located on the plurality of relay paths, wherein based on the connection information, each of the relay nodes located on the plurality of relay paths relays to the first terminal data fragments which are among a plurality of data fragments constituting data held by the second terminal and which are assigned to each of the located relay nodes.

### BRIEF DESCRIPTION OF THE DRAWINGS

FIG. 1 is a configuration diagram showing a communication system as one embodiment of the present disclosure;

FIG. 2 is a block diagram showing a connection server in the embodiment of the disclosure;

FIG. 3 is an explanatory view explaining connection information about the embodiment of the disclosure;

FIG. 4 is an explanatory view explaining logical distance information about the embodiment of the disclosure;

FIG. 5 is an explanatory view explaining a communication method for use with the embodiment of the disclosure;

FIG. 6 is another explanatory view explaining the communication method for use with the embodiment of the disclosure; and

FIG. 7 is another explanatory view explaining the communication method for use with the embodiment of the disclosure.

### DESCRIPTION OF THE DISCLOSURE

A communication system embodying the present disclosure will now be described in reference to the accompanying figures. Throughout the figures, like reference symbols designate like parts.

It should be noted that the figures are not drawn to scale and that the proportions of illustrated parts do not reflect actual dimensions as they relate to implementation of the disclosure. Specific sizes and dimensions of the parts should be determined in consideration of the ensuing description. Between the figures, the proportions of and the relations between the corresponding parts may be different.

### Outline of the Embodiment

As an aspect of the present embodiment, the communication system has a plurality of relay nodes including a first and a second relay nodes, and a connection server that manages these relay nodes. Data held by a second terminal at service of a second relay node is relayed to a first terminal at service of a first relay node. The connection server includes a management part that manages connection information used for the first terminal to access the second terminal, and logical distance information indicative of logical distances between the plurality of relay nodes; a selection part that selects, based on the logical distance information, a plurality of relay paths over which the data held by the second terminal is relayed to the first terminal; and a notification section that gives notification of the connection information to the relay nodes located on the plurality of relay paths. By use of the connection information, each of the relay nodes located on the plurality of relay paths relays to the first terminal data fragments which are among a plurality of data fragments constituting the data held by the second terminal and which are assigned to each of the located relay nodes.

With this embodiment, it is the selection part that selects a plurality of relay paths over which the data held by the second terminal is relayed to the first terminal. This arrangement alleviates the burden involved in relaying data from the second terminal to the first terminal.

Also, the notification section gives notification of the connection information to the relay nodes located on the plurality of relay paths. This arrangement makes it possible for the second terminal at service of a device equipped with the NAT or firewall function to relay data to the first terminal.

If the second relay node has the IP address translation function (i.e., NAT function), the connection information is local IP address information about the second terminal. If the second relay node has the firewall function, the connection information is port number information about the second terminal.

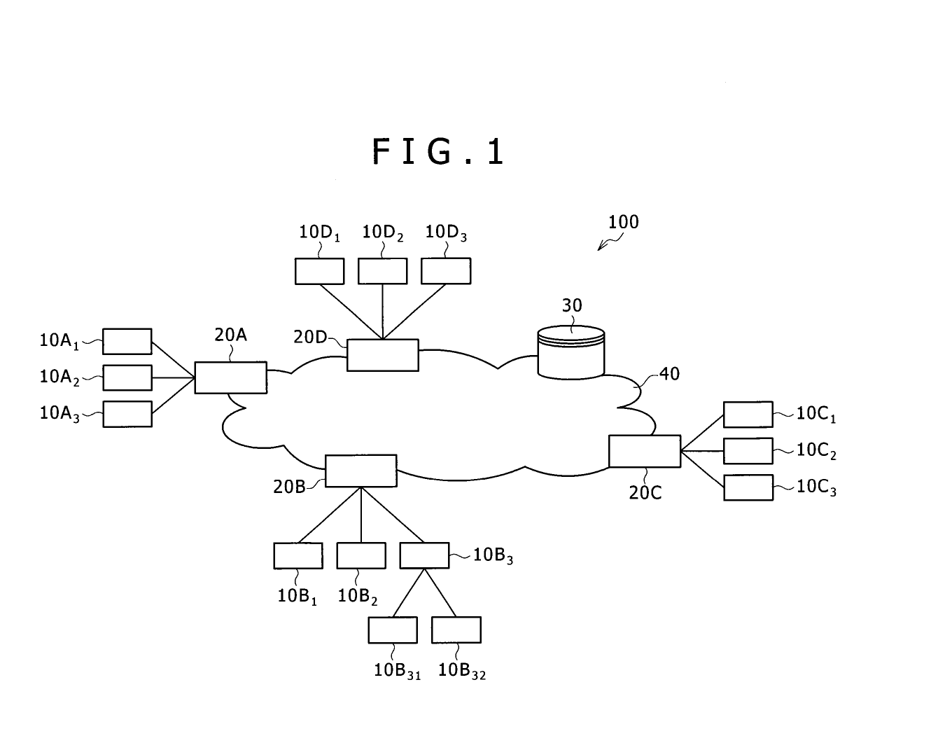

Explained below is a communication system as one embodiment of the present disclosure. FIG. 1 is a block diagram showing a typical configuration of the communication system 100 embodying this disclosure.

The communication system 100 is configured to include at least one gateway 20 and a connection server 30. The gateway 20 and connection server 30 are connected to a wide area communication network 40 such as the Internet. At least one terminal 10 is connected to each of the gateways 20 configured. The terminals 10 connected to the gateways 20 conduct communications through each connected gateway 20. In this embodiment, the terminals 10 are said to be at service of the gateways 20.

The terminal 10 may be a personal computer, a mobile phone or the like. The terminals 10 are at service of the gateways 20 and are connected to the latter via a wired or wireless LAN.

In this embodiment, terminals 10A1, 10A2 and 10A3 are at service of a gateway 20A; terminals 10B1, 10B2, 10B3, 10B31 and 10B32 are at service of a gateway 20B; terminals 10C1, 10C2 and 10C3 are at service of a gateway 20C; and terminals 10D1, 10D2 and 10D3 are at service of a gateway 20D.

The gateway 20 is a device that manages a plurality of terminals 10. The gateway 20 has a function that interconnects the multiple terminals 10 with the wide area communication network 40. The gateway 20 may also have the IP address translation function (NAT function) or the firewall function.

Furthermore, the gateways 20 may each include a function for gaining access to the terminal 10 at their service via the wide area communication network 40. For example, the function for accessing the terminals 10 may be DDNS (Dynamic Domain Name System). Under the DDNS, each gateway 20 transmits periodically the connection information (IP addresses) about the terminals 10 at its service to the connection server 30. As another example, the function for gaining access to the terminals 10 may be the PP (Port Punching) function. Under the PP scheme, each gateway 20 transmits the connection information (port numbers) of the terminals 10 at its service to the connection server 30.

As its gateways 20, this embodiment includes the gateways 20A, 20B, 20C and 20D, for example. In this embodiment, the gateways 20 also function as relay nodes for relaying the data held by a given terminal 10 (second terminal) to another terminal 10 (first terminal).

The connection server 30 is a device that manages a plurality of gateways 20. For example, the connection server 30 has the function of selecting a plurality of relay paths over which the data held by a given terminal 10 (second terminal) is relayed to another terminal 10 (first terminal). The connection server 30 will be discussed later in more detail.

In one example in connection with this embodiment, the terminal 10A1 at service of the gateway 20A (first relay node) acts as the first terminal, and the terminal 10B32 at service of the gateway 20B (second relay node) serves as the second terminal. That is, with this embodiment, the terminal 10A1 accesses the terminal 10B32 so as to acquire the data held by the terminal 10B32. Also, the data held by the terminal 10B32 is relayed to the terminal 10A1 via a plurality of relay paths.

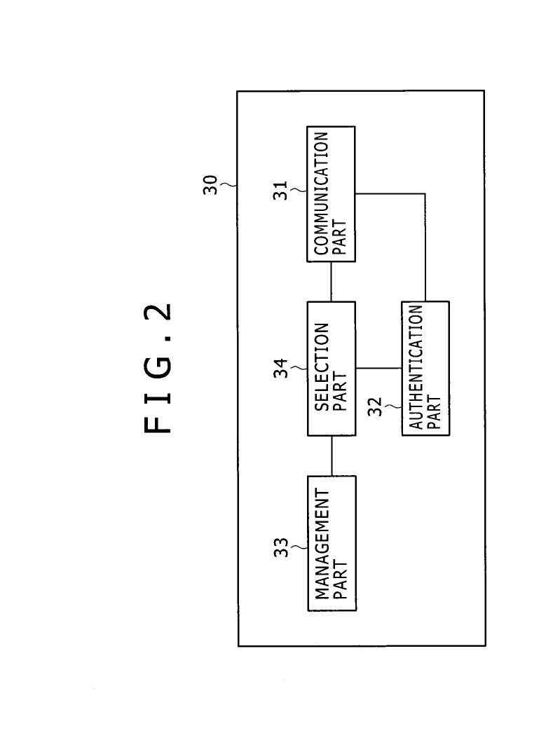

The ensuing paragraphs will explain the connection server 20 of this embodiment. FIG. 2 is a block diagram showing a typical configuration of the connection server 30 in this embodiment.

As shown in FIG. 2, the connection server 30 includes a communication part 31, an authentication part 32, a management part 33, and a selection part 34.

The communication part 31 communicates with devices located on the wide area communication network 40. For example, the communication part 31 communicates with each of the gateways 20. The communication part 31 acquires from each gateway 20 the information indicative of the function type for accessing a given terminal at service of a given gateway 20. For example, the information indicative of the function type (access function type) is information indicating that the DDNS (Dynamic Domain Name System) is in effect or that PP (Port Punching) is in use, as discussed above. The communication part 31 also acquires connection information (local IP address, port number, etc.) about the terminals 10 at service of each gateway 20. The communication part 31 further obtains from each gateway 20 logical distance information indicative of logical distances between the gateways 20 configured. The logical distance information is acquired, for example, on the basis of the time it takes for a signal to make a round trip between a pair of gateways 20. A given gateway 20k measures in advance the time it takes for a signal to make a round trip to another gateway 20i (i=1, k−1, k+1, . . . ).

The gateway 20k then keeps in storage the logical distance information generated based on the time required for a signal to make a round trip to another gateway 20i (i≠k) in association with the information identifying the gateway 20i (i≠k) in question. Specifically, the longer it takes for a signal to make a round trip, the greater in magnitude the logical distance information that may be acquired.

The authentication part 32 authenticates access from the first terminal (e.g., terminal 10A1) to the second terminal (e.g., terminal 10B32). For example, the authentication part 32 obtains such authentication information as a user ID and a password from the first terminal in order to determine whether or not to authorize access from the first terminal to the second terminal.

The management part 33 manages the information necessary for relaying the data held by the second terminal (e.g., terminal 10B32) to the first terminal (e.g., terminal 10A1).

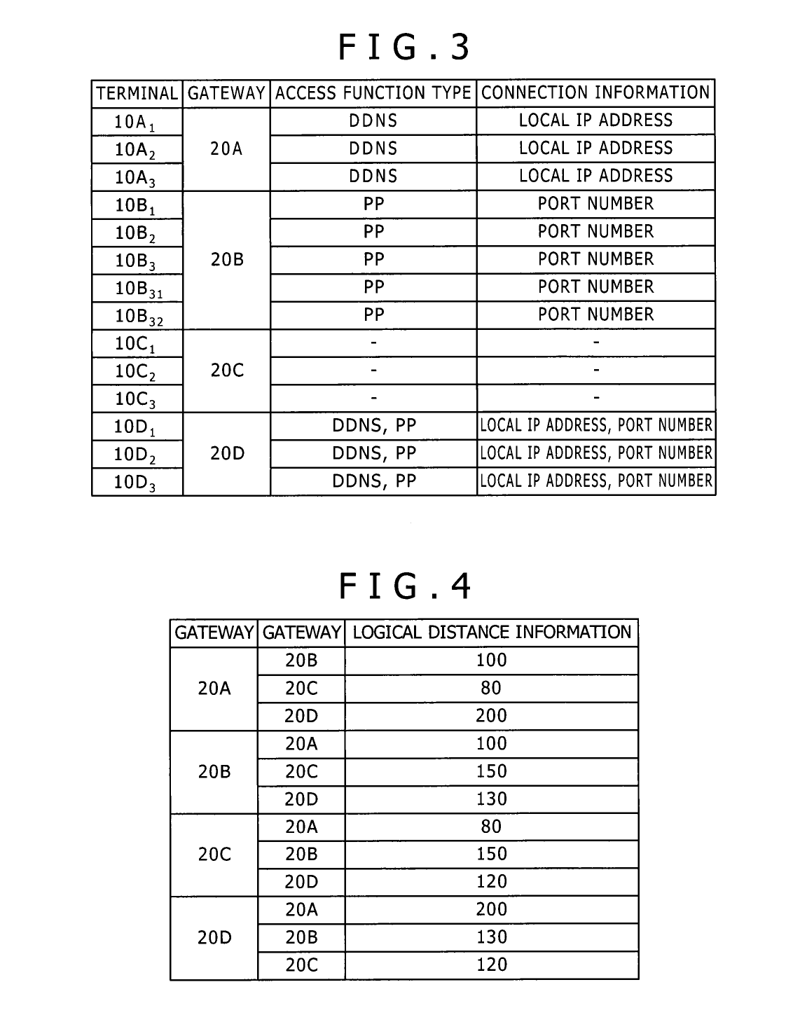

Primarily, the management part 33 manages connection information used for the first terminal (e.g., terminal 10A1) to gain access to the second terminal (e.g., terminal 10B32). For example, the management part 33 manages information associating each terminal with the corresponding gateway, access function type, and connection information, as shown in FIG. 3. As mentioned above, the access function type is information indicative of the type of the access function in use such as the DDNS (Dynamic Domain Name System) or PP (Port Punching). For example, if the gateway 20 (e.g., gateway 20A) uses the NAT function and DDNS function, the connection information is the local IP addresses of the terminals 10. If the gateway 20 (e.g., gateway 20B) uses the firewall function and PP function, the connection information is the port numbers of the terminals 10. If the gateway 20 (e.g., gateway 20D) uses the NAT function, DDNS function, firewall function, and PP function, the connection information is the local IP addresses and port numbers of the terminals 10.

Secondly, the management part 33 manages the logical distance information indicative of logical distances between a plurality of gateways 20. For example, as shown in FIG. 4, the management part 33 manages information associating each pair of gateways 20 with information about the logical distance therebetween. The logical distance information may be expressed numerically as shown in FIG. 4.

The selection part 34 selects at least one relay path over which the data held by the second terminal (e.g., terminal 10B32) is relayed to the first terminal (e.g., terminal 10A1) on the basis of the logical distance information. More specifically, when access from the first terminal (e.g., terminal 10A1) to the second terminal (e.g., terminal 10B32) is authorized, the selection part 34 selects at least one relay path.

In another example, the selection part 34 may vary the number of relay paths to be selected on the basis of the amount of the data to be relayed from the second terminal to the first terminal. Specifically, the selection part 34 may determine the number of relay paths in proportion to the amount of the data to be relayed. In this example in connection with the embodiment, the larger the amount of the relay data, the greater the number of relay paths to be selected by the selection part 34.

In a further example, the selection part 34 may select a relay path based on the type of the data to be relayed from the second terminal to the first terminal. Specifically, the selection part 34 may select the relay path in accordance with the degree of real-time nature in relaying data. That is, the higher the degree of real-time nature of the relay data, the shorter the logical distance of the relay path that may be selected by the selection part 34.

In an even further example, the selection part 34 may select a plurality of relay paths based on the loads of the gateways 20. Specifically, the selection part 34 may select relay paths in a manner averaging the loads of the gateways 20.

It should be noted that in this embodiment, the above-described communication part 31 constitutes a notification section giving notification of the connection information (about the first and the second terminals) to the gateways 20 located on a plurality of relay paths.

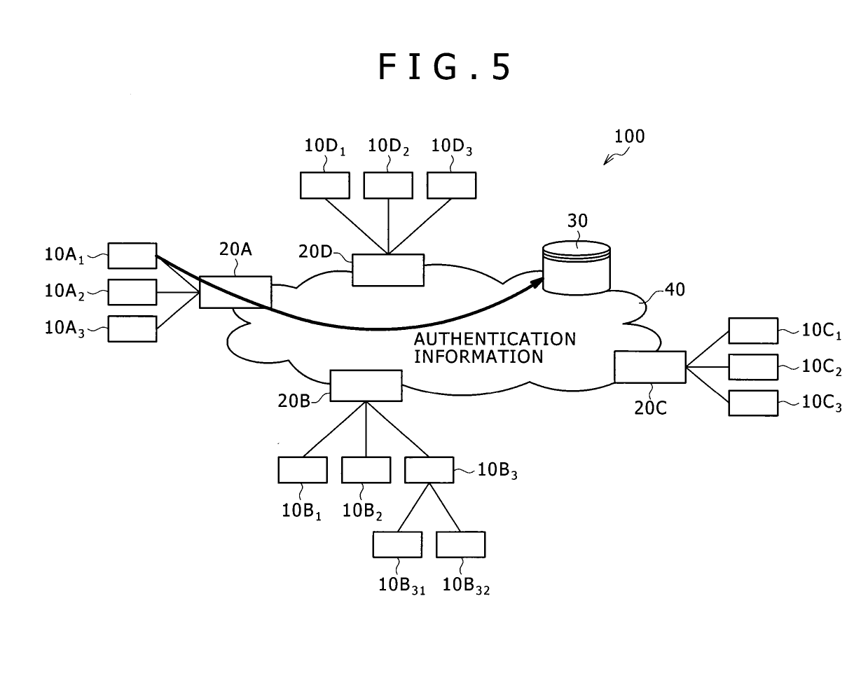

The ensuing paragraphs will explain the communication method for use with this embodiment. FIGS. 5 through 7 are explanatory views explaining the communication method for use with the above-described embodiment of the disclosure.

In FIGS. 5 through 7, as discussed above, the terminal 10A1 is shown as the first terminal at service of the gateway 20A (first relay node). The terminal 10B32 is shown as the second terminal at service of the gateway 20B (second relay node).

The terminal 10A1 transmits, as shown in FIG. 5, authentication information such as a user ID and a password to the connection server 30. Based on the authentication information thus transmitted, the connection server 30 determines whether or not to authorize access from the terminal 10A1 to the terminal 10B32. For purpose of explanation, it is assumed here that the access from the terminal 10A1 to the terminal 10B32 is authorized.

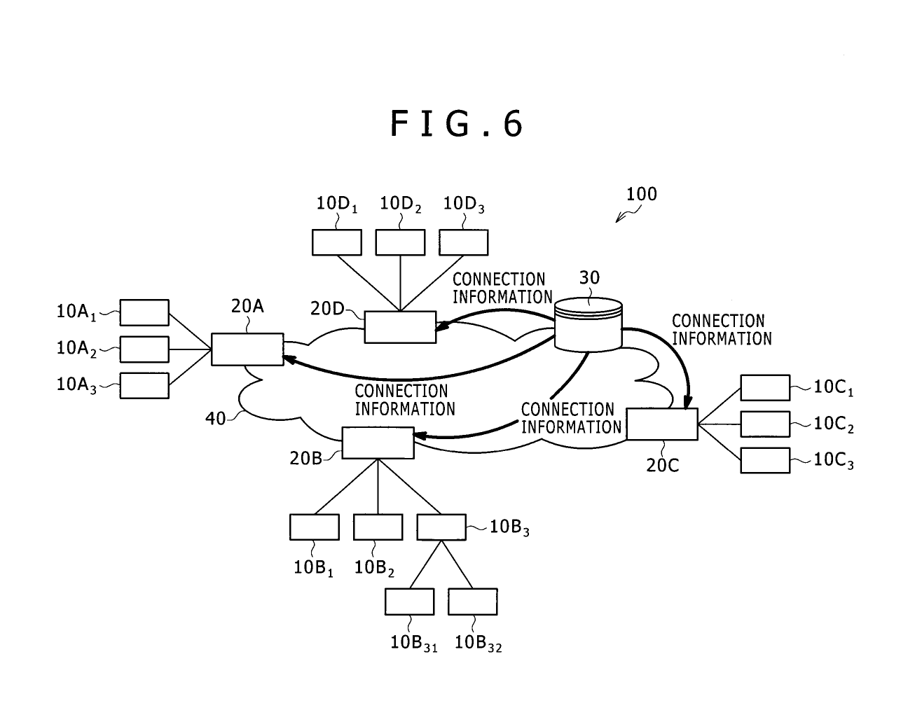

The connection server 30 selects, as shown in FIG. 6, a plurality of relay paths and gives notification of the connection information about the first and the second terminals to the gateways 20 located on the selected plurality of relay paths.

For purpose of explanation, it is assumed here that three relay paths have been selected: a relay path (1) connecting the gateways 20B and 20A; a relay path (2) connecting the gateways 20B, 20C and 20A; and a relay path (3) connecting the gateways 20B, 20D and 20A.

For example, the connection server 30 notifies the gateways 20A, 20C and 20D of the connection information about the terminal 10B32. The connection server 30 also notifies the gateways 20B, 20C and 20D of the connection information about the terminal 10A1.

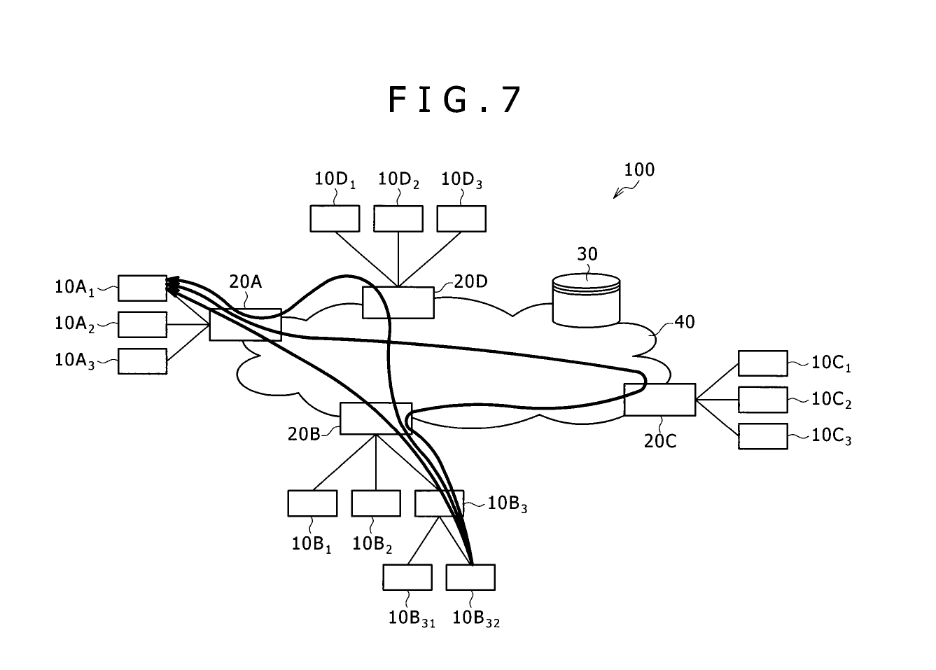

As shown in FIG. 7, by use of the connection information, each of the gateways 20 located on the plurality of relay paths relays to the terminal 10A1 data fragments which are among a plurality of data fragments constituting the data held by the terminal 10B32 and which are assigned to each of the located gateways 20.

In this embodiment, the selection part 34 selects a plurality of relay paths over which the data held by the second terminal is relayed to the first terminal. This arrangement alleviates the burden involved in relaying data from the second terminal to the first terminal.

The communication part 31 gives notification of connection information to the relay nodes located on the plurality of relay paths. This arrangements permits relaying of data to the first terminal from the second terminal at service of a device that has the NAT function and/or firewall function.

### Another Aspect of the Embodiment

It is to be understood that while the present disclosure has been described in conjunction with a specific embodiment, such description is for illustrative purposes only. It is evident that many alternatives, modifications and variations will become apparent to those skilled in the art in light of the foregoing description.

For example, while foregoing description of the embodiment has shown the gateways 20 as the relay nodes, this is not limitative of the present disclosure. Alternatively, the relay nodes may be other devices (e.g., servers) located on the wide area communication network 40.

Also, while the foregoing description of the embodiment has shown the DDNS function and PP function as the functions for gaining access to the terminals 10, other known functions may be adopted alternatively for gaining access to the terminals 10.

Furthermore, while the foregoing description of the embodiment has shown that the connection server 30 selects a plurality of relay paths, the first terminal may alternatively select a plurality of relay paths. In this case, the first terminal acquires from the connection server 30 the information necessary for relaying the data held by the second terminal to the first terminal. As another alternative, the first terminal may give notification of connection information to the relay nodes located on the plurality of relay paths.

In the above-described embodiment, the connection information used for the first terminal to gain access to the second terminal is about the first and the second terminals.

However, if the first terminal is not at service of a device equipped with the NAT function or firewall function, the connection information used for the first terminal to access the second terminal may be about the second terminal only.

It should be understood by those skilled in the art that various modifications, combinations, sub-combinations and alterations may occur depending on design requirements and other factors insofar as they are within the scope of the appended claims or the equivalents thereof.

What is claimed is:

1. A connection server connected to a plurality of relay nodes including a first and a second relay nodes, the connection server comprising:
a management part that manages connection information for a first terminal at service of the first relay node to access a second terminal at service of the second relay node, and logical distance information indicative of logical distances between the plurality of relay nodes;
a selection part that selects, based on the logical distance information, a plurality of relay paths over which data held by the second terminal is relayed to the first terminal; and
a notification section that notifies the connection information to the relay nodes located on the plurality of relay paths.

2. The connection server of claim 1, further comprising:
an authentication part that authenticates access from the first terminal to the second terminal.

3. The connection server of claim 2, wherein
the selection part selects the plurality of relay paths when the access from the first terminal to the second terminal is authenticated.

4. The connection server of claim 1, wherein
the selection part selects the plurality of relay paths based on an amount of the data to be relayed from the second terminal to the first terminal.

5. The connection server of claim 1, wherein
the selection part selects the plurality of relay paths based on a type of the data to be relayed from the second terminal to the first terminal.

6. The connection server of claim 1, wherein
the second relay node has an Internet Protocol address translation function, and
the connection information is local Internet Protocol address information corresponding to the second terminal.

7. The connection server of claim 1, wherein
the second relay node has a firewall function, and
the connection information is a port number of the second terminal.

8. A method performed by a connection server connected to a plurality of relay nodes including a first and a second relay nodes, the method comprising:
managing, by a processor of the connection server, connection information for a first terminal at service of the first relay node to access a second terminal at service of the second relay node, and logical distance information indicative of logical distances between the plurality of relay nodes;
selecting, by the processor based on the logical distance information, a plurality of relay paths over which data held by the second terminal is relayed to the first terminal; and
notifying, by a communication interface of the connection server, the connection information to the relay nodes located on the plurality of relay paths.

9. A communication system, comprising:
a plurality of relay nodes; and
a connection server configured to manage said plurality of relay nodes, the connection server including
a management part that manages connection information for a first terminal at service of a first of the plurality of relay nodes to access a second terminal at service of a second of the plurality of relay nodes, and logical distance information indicative of logical distances between the plurality of relay nodes;
a selection part that selects, based on the logical distance information, a plurality of relay paths over which the data held by the second terminal is relayed to the first terminal; and
a notification section that notifies the connection information to the relay nodes located on the plurality of relay paths, wherein
based on the connection information, each of the relay nodes located on the plurality of relay paths relays to the first terminal data fragments which are among a plurality of data fragments constituting data held by the second terminal and which are assigned to each of the located relay nodes.
